(19) United States
(12) Patent Application Publication
(10) Pub. No.: US 2025/0286107 A1
(43) Pub. Date: Sep. 11, 2025

(54) JELLY ROLL AND BATTERY

(71) Applicant: ZHUHAI COSMX BATTERY CO., LTD., Zhuhai (CN)

(72) Inventor: Jialin FANG, Zhuhai (CN)

(73) Assignee: ZHUHAI COSMX BATTERY CO., LTD., Zhuhai (CN)

(21) Appl. No.: 19/210,147

(22) Filed: May 16, 2025

Related U.S. Application Data
(63) Continuation of application No. 19/069,404, filed on Mar. 4, 2025.

(30) Foreign Application Priority Data
Mar. 5, 2024 (CN) 202410250583.7

(51) Int. Cl. H01M 10/04; H01M 4/02; H01M 4/36; H01M 4/38; H01M 4/583

(52) U.S. Cl. CPC H01M 10/0431; H01M 4/364; H01M 4/366; H01M 4/386; H01M 4/583; H01M 2004/021; H01M 2004/027

(57) ABSTRACT

Disclosed are a jelly roll and a battery. The jelly roll includes a first electrode plate and a second electrode plate, where the first electrode plate includes a first current collector and first active material layers coated on two sides of the first current collector; a first tab groove is provided in the first active material layer; a bottom wall of the first tab groove is the first current collector; a peripheral side of the first tab groove is the first active material layer; the first tab groove extends to an edge of the first current collector in a second direction; a first tab that is electrically connected to the first current collector is arranged in the first tab groove; the second electrode plate includes a second current collector and second active material layers coated on two sides of the second current collector.

### CROSS-REFERENCE TO RELATED APPLICATIONS

This application is a continuation of U.S. patent application Ser. No. 19/069,404, filed on Mar. 4, 2025, which claims priority to Chinese Patent Application No. 202410250583.7, filed on Mar. 5, 2024, both of which are hereby incorporated by reference in their entireties.

### TECHNICAL FIELD

The present disclosure relates to the field of battery technologies, and in particular, to a jelly roll and a battery.

### BACKGROUND

With the advent of the 5G era and the rapid development of battery technologies, people impose higher requirements for energy densities, fast charging capacities, and charge and discharge rates of batteries. Therefore, fast-charging lithium-ion batteries have become a main type of consumer lithium-ion batteries.

Currently, under a high-rate charge/discharge operating condition or in a long-term full-load running state, a battery, especially a position in the battery where a tab is provided, faces a relatively serious problem of heat generation. How to improve heat dissipation of a battery is an important issue that is to be addressed to ensure or prolong a life of the battery. A key research direction for those skilled in the art is how to improve heat dissipation performance of a battery by using a reasonable structure, so as to lower a temperature of the battery during operation, thereby preventing reduction of a service life of the battery.

### SUMMARY

Embodiments of the present disclosure provide a jelly roll and a battery that are mainly used to resolve problems in the prior art such as battery overheating during high-rate charging and discharging. According to the present disclosure, space utilization is improved, and heat can be effectively dissipated during a charging process of the battery, thereby improving the performance of the battery such as safety.

The present disclosure provides a jelly roll, including a first electrode plate and a second electrode plate.

The first electrode plate includes a first current collector and first active material layers coated on two sides of the first current collector; a tab groove is provided in the first active material layer; a bottom wall of the tab groove is the first current collector; a peripheral side of the tab groove is the first active material layer; the tab groove extends to an edge of the first current collector in a second direction; and a first tab that is electrically connected to the first current collector is arranged in the tab groove.

The second electrode plate includes a second current collector and second active material layers coated on two sides of the second current collector; a thinning groove is provided in the second active material layer opposite the tab groove; a thickness of the second active material layer in the thinning groove is less than a thickness of the second active material layer in a region that is of the second current collector and is not provided with the thinning groove; first protective adhesive paper is arranged in the thinning groove; in a width direction of the first tab, a width of the first tab is not greater than a width of the first protective adhesive paper; and the second current collector is provided with a second edge in a second direction.

The thinning groove is arranged in a jelly roll straight section; a first gap is provided between the thinning groove and the second edge; a projection of the first gap in a first direction at least partially overlaps with a projection of the first tab in the first direction; and a second gap is provided between the thinning groove and a jelly roll arc section on a side that is most adjacent to the thinning groove.

The following beneficial effect can be achieved by using the above configurations. In one aspect, the first gap is provided, so that the second active material layer at the first gap can tightly abut against the first tab, thereby improving the conduction efficiency of heat on the electrode plate. In another aspect, the second gap is provided, so that a conduction channel is formed around a periphery of the first tab, so that heat of the electrode plate surrounding the first tab can be uniformly and quickly conducted to the periphery of the first tab. Therefore, the heat dissipation efficiency of the jelly roll is improved, thereby ensuring that the jelly roll can effectively dissipate heat during a high-rate charging/discharging process, and thus improving the performance of the jelly roll such as safety. In addition, the following beneficial effects can be achieved by the thinning groove. In one aspect, because part of an active material is reserved in the thinning groove, a solder print of the first tab can abut against the active material in the thinning groove, and the active material in the thinning groove and an active material in a peripheral region of the thinning groove are arranged continuously, so that heat of the electrode plate can also be dissipated quickly through the active material abutting against the solder print of the first tab, thereby further improving the heat dissipation efficiency of the jelly roll. In another aspect, the thinning groove is provided to reduce a thickness of the first tab, so as to reduce an overall thickness of the jelly roll, so that the space utilization of the jelly roll is improved, thereby improving energy density. In some implementations, a width of the first gap in the second direction is A; and a width of the second gap in a third direction of the first current collector is B, where A and B meet: 2 mm<B, and/or 0.8≤A/B≤1.2.

It should be noted that a ratio of the first gap A to the second gap B is greater than or equal to 0.8 and less than or equal to 1.2. This is because an extended region of the first gap A overlaps with an extended region of the second gap B, resulting in that too much heat is accumulated at an overlapping position, and the heat cannot be dissipated quickly.

In some implementations, a first notch is provided in a first edge of the first current collector; the first notch is communicated with the tab groove; the first notch extends to an edge of the first current collector; and a distance between a projection of a bottom wall of the first notch in the second direction and the second edge is m, where m meets: m>A.

In some implementations, in the second direction, a distance between the first protective adhesive paper and an edge of the thinning groove is C, where C meets: 0 mm<C<5 mm; and/or

in a length direction of the first current collector, a distance between the first protective adhesive paper and an edge of the thinning groove is D, where D meets: 0 mm<D<5 mm.

It should be noted that due to this configuration, a region covered by the first protective adhesive paper, the thinning groove, and the second active material layer form a stepped funnel due to thickness difference, thereby facilitating storing an electrolyte solution in the stepped funnel. The electrolyte solution absorbs heat generated by the first tab, so as to reduce a temperature rise.

In some optional implementations, a plurality of first grooves are provided in the second active material layer; and the first groove extends in the second direction; and

the plurality of first grooves are spaced in at least one of an arc section of the second active material layer or a straight section of the second active material layer.

It should be noted that the first groove is provided, so that heat at the first tab can be dissipated to an outer side of the jelly roll, that is, the heat at the first tab may be dissipated towards the second active material layer and the arc section of the second active material layer, and then dissipated through a first heat dissipation channel in the first groove, thereby facilitating heat dissipation.

In some implementations, a depth H of the first groove and a fracture elongation e of the second current collector meet: 1 mm≤H/e≤15 mm; and

the second electrode plate is further provided with a second tab; and a depth H of the first groove, a width L of the first groove, a tab width E of the first tab or the second tab, and a tab thickness F of the first tab or the second tab meet: 2*10⁻⁴ mm⁴≤H*L*E*F≤2*10⁻³ mm⁴.

It should be noted that a larger fracture elongation of the current collector indicates that the current collector can bear a larger stress and a larger laser intensity, and indicates that the first groove is deeper.

It should be noted that a smaller width or thickness of the first tab or the second tab leads to generating more heat, which requires a larger area of a heat-conducting and gas-guiding channel.

In some implementations, a ceramic layer is coated on at least one side surface of the first electrode plate away from a tail end of a winding center; and part of the ceramic layer covers the first active material layer;

a coating thickness of the ceramic layer is greater than or equal to 5 μm and less than or equal to 20 μm; and/or

a ratio of a ceramic particle size of the ceramic layer to a width of the first groove is greater than or equal to 1/20 and less than or equal to ¼.

It should be noted that the ceramic layer facilitates heat absorption, so as to reduce an overall temperature rise of a battery.

In some implementations, a second groove is provided in the first active material layer away from the tail end of the winding center; and part of the ceramic layer covers the second groove; and

a depth of the second groove is greater than or equal to 0 μm and less than or equal to 20 μm.

It should be noted that the second groove is provided to offset the thickness of the ceramic layer and to facilitate reduction of the thickness of the ceramic layer, thereby preventing an overlapped region from being thicker than other positions, which affects flatness of a battery cell. Ceramics facilitate heat absorption, so as to reduce an overall temperature rise of a battery.

In some implementations, at least part of a projection of the ceramic layer in the first direction is located in the thinning groove.

It should be noted that this configuration shortens a heat conducting path, so that heat can be conducted to the ceramic layer conveniently.

In some implementations, the second active material layer includes a first material layer and a second material layer; and the first material layer and the second material layer are stacked sequentially in the first direction, where the first material layer is arranged on a side away from the second current collector.

In some implementations, at least one of the first material layer or the second material layer is made of a silicon-doped graphite material, where a particle size of a graphite particle of the first material layer is smaller than a particle size of a graphite particle of the second material layer.

A ratio of a thickness of the first material layer to a thickness of the second active material layer is greater than or equal to 20% and less than or equal to 60%.

It should be noted that the second active material layer includes two layers of graphite, where graphite of the lower layer is large-particle graphite, graphite of the upper layer is small-particle graphite, and a ratio of a thickness of the small-particle graphite of the upper layer to a total thickness of the second active material layer ranges from 20% to 60%. A linear first groove is formed by etching the second electrode plate by using a laser. A depth h of the first groove is less than the thickness of the first material layer. A porosity of the small-particle graphite of the upper layer is larger, thereby facilitating gas guiding and heat conduction.

In some implementations, at least one of the first material layer or the second material layer is made of a mixed material including at least one of a graphite material or a silicon-carbon material, where a ratio of the silicon-carbon material to the mixed material is greater than or equal to 2% and less than or equal to 15%; and/or

a width L of the first groove and a particle size M of the silicon-carbon material meet:L≥2M, where 50 μm≤L≤100 μm.

It should be noted that the second active material layer is made of a silicon-carbon-doped graphite material. Silicon-carbon particles undergo relatively large expansion during a charging/discharging process. Compared with graphite, silicon-carbon undergoes more side reactions when being in contact with an electrolyte solution, resulting generation of gas and heat. A linear first groove is formed by etching the second electrode plate by using a laser, so that sufficient space is provided to ensure that the silicon-carbon material undergoing expansion can be accommodated during a cyclic charging and discharging process and that the first heat dissipation channel is unobstructed.

In some implementations, a lithium supplement layer is arranged on a side surface of the second electrode plate; and a thickness of the lithium supplement layer is less than or equal to a depth of the first groove.

It should be noted that the surface of the second electrode plate is provided with the lithium supplement layer, and the depth h of the first groove is greater than the thickness of the lithium supplement layer, so that a linear channel of the first groove still exists in the surface of the electrode plate subjected to lithium supplement, thereby facilitating gas guiding and heat conduction.

In some implementations, second protective adhesive paper is arranged at a tail end of the first electrode plate; and a ratio of a width of the second protective adhesive paper to a width of the jelly roll is greater than or equal to ½ and less than or equal to 1; and/or

the width of the second protective adhesive paper is greater than or equal to 10 mm and less than or equal to 40 mm.

It should be noted that the second protective adhesive paper is guaranteed to exceed tail-end bare foil (or be coated with a ceramic layer) after passing over an arc, and that an adhesive bonding relationship between the second protective adhesive paper and tail-end hot-melt adhesive is as follows: in a width direction of the jelly roll, the second protective adhesive paper exceeds the hot-melt adhesive, and the hot-melt adhesive is bonded above the second protective adhesive paper, so that the hot-melt adhesive can be prevented from tearing the first electrode plate.

In some implementations, third protective adhesive paper is arranged on the tab groove in a side of the first electrode plate; and the third protective adhesive paper is configured to cover the thinning groove.

It should be noted that the third protective adhesive paper can prevent a short-circuit fire risk caused when a burr of a solder joint at the first tab pierces through a separator.

The present disclosure further provides a battery, including the jelly roll described above.

According to the jelly roll and the battery provided in the present disclosure, the battery includes the jelly roll; the jelly roll includes a first electrode plate and a second electrode plate; the first electrode plate includes a first current collector and first active material layers coated on two sides of the first current collector; a first tab groove is provided in the first active material layer; a bottom wall of the first tab groove is the first current collector; a peripheral side of the first tab groove is the first active material layer; the first tab groove extends to an edge of the first current collector in a second direction; a first tab that is electrically connected to the first current collector is arranged in the first tab groove; the second electrode plate includes a second current collector and second active material layers coated on two sides of the second current collector; a thinning groove is provided in the second active material layer opposite the first tab groove; a thickness of the second active material layer in the thinning groove is less than a thickness of the second active material layer in a region that is of the second current collector and is not provided with the thinning groove; first protective adhesive paper is arranged in the thinning groove; a projection of the first tab in a first direction is in a projection of the first protective adhesive paper in the first direction; the second current collector is provided with a second edge in a second direction; the thinning groove is located in a jelly roll straight section; a first gap is provided between the thinning groove and the second edge; a projection of the first gap in the first direction at least partially overlaps with a projection of the first tab in the first direction; and a second gap is provided between the thinning groove and a jelly roll arc section on a side that is most adjacent to the thinning groove.

The following beneficial effect can be achieved by using the above configurations. In one aspect, the first gap is provided, so that the second active material layer at the first gap can tightly abut against the first tab, thereby improving the conduction efficiency of heat on the electrode plate. In another aspect, the second gap is provided, so that a conduction channel is formed around a periphery of the first tab, and thus heat of the electrode plate surrounding the first tab can be uniformly and quickly conducted to the periphery of the first tab. Therefore, the heat dissipation efficiency of the jelly roll is improved, thereby ensuring that the jelly roll can effectively dissipate heat during a high-rate charging/discharging process, and thus improving the performance of the jelly roll such as safety. In addition, the following beneficial effects can be achieved by the thinning groove. In one aspect, because part of an active material is reserved in the thinning groove, a solder print of the first tab can abut against the active material in the thinning groove, and the active material in the thinning groove and an active material in a peripheral region of the thinning groove are arranged continuously, so that heat of the electrode plate can also be dissipated quickly through the active material abutting against the solder print of the first tab, thereby further improving the heat dissipation efficiency of the jelly roll. In another aspect, the thinning groove is provided to reduce a thickness of the first tab, so as to reduce an overall thickness of the jelly roll, so that the space utilization of the jelly roll is improved, thereby improving energy density.

### BRIEF DESCRIPTION OF THE DRAWINGS

To describe the technical solutions in embodiments of the present disclosure or a conventional technology more clearly, the following briefly describes the accompanying drawings required for describing the embodiments or the conventional technology. Apparently, the accompanying drawings in the following description show some embodiments of the present disclosure, and persons of ordinary skill in the art may still derive other drawings from these accompanying drawings without creative efforts.

FIG. 1 is a schematic structural diagram of a jelly roll from a first angle of view according to an embodiment of the present disclosure.

FIG. 2 is a schematic structural diagram of a first electrode plate in a jelly roll according to an embodiment of the present disclosure.

FIG. 3 is a schematic structural diagram of a second electrode plate in a jelly roll according to an embodiment of the present disclosure.

FIG. 4 is a schematic diagram of an unwound structure of a jelly roll according to an embodiment of the present disclosure.

FIG. 5 is a schematic structural diagram of a jelly roll from a second angle of view according to an embodiment of the present disclosure.

FIG. 6 is a sectional view of a second electrode plate in a jelly roll according to an embodiment of the present disclosure.

FIG. 7 is a schematic structural diagram of a first tab in a jelly roll according to an embodiment of the present disclosure.

FIG. 8 is a schematic structural diagram of a particle of a silicon-carbon material in a jelly roll according to an embodiment of the present disclosure.

### DETAILED DESCRIPTION OF THE EMBODIMENTS

To make the objectives, technical solutions, and advantages of embodiments of the present disclosure clearer, the following clearly and completely describes the technical solutions in embodiments of the present disclosure with reference to the accompanying drawings in the embodiments of the present disclosure. Apparently, the described embodiments are some rather than all of the embodiments of the present disclosure. All other embodiments obtained by persons of ordinary skill in the art based on embodiments of the present disclosure without creative efforts fall within the protection scope of the present disclosure. In a case of no conflict, the following embodiments and features in the embodiments may be combined with each other.

In the descriptions of the present disclosure, it should be understood that the orientations or positional relationships indicated by the terms “center”, “vertical”, “transverse”, “length”, “width”, “thickness”, “upper”, “lower”, “front”, “rear”, “left”, “right”, “vertical”, “horizontal”, “top”, “bottom”, “inside”, “outside”, “clockwise”, “counterclockwise”, “axial”, “radial”, “circumferential”, and the like are based on the orientations or positional relationships shown in the accompanying drawings, are merely intended to facilitate the descriptions of the present disclosure and simplify the descriptions, are not intended to indicate or imply that the apparatuses or components mentioned in the present disclosure necessarily have specific orientations, or be constructed and operated for a specific orientation, and therefore shall not be construed as a limitation to the present disclosure.

In the present disclosure, unless specified and defined explicitly otherwise, the terms “mounted”, “join”, “connect”, “fixed”, and the like should be understood in a broad sense. For example, “connection” may be a fixed connection, a detachable connection, or an integral connection; or may be a direct connection or an indirect connection by means of an intermediate medium; or may be a communication between inner cavities of two elements or an interactive relationship between two elements. Persons of ordinary skill in the art may understand specific meanings of these terms in the present disclosure based on specific situations.

It should be noted that in the description of the present disclosure, the terms “first”, “second”, “third”, and the like are merely intended to facilitate description of different cavities, and shall not be understood as an indication or implication of a sequence relationship or relative importance or implicit indication of the quantity of indicated technical features. Therefore, a feature limited by “first”, “second”, or “third” may explicitly or implicitly include at least one such feature.

Currently, under a high-power operating condition or in a long-term full-load running state, a battery faces a relatively serious problem of heat generation. How to improve heat dissipation of a battery is an important issue that is to be addressed to ensure or prolong a life of the battery. A key research direction for those skilled in the art is how to improve heat dissipation performance of a battery by using a reasonable structure, so as to lower a temperature of the battery during operation, thereby preventing reduction of a service life of the battery.

To overcome the defects in the prior art, the present disclosure provides a jelly roll and a battery. In one aspect, a first gap is provided, so that a second active material layer at the first gap can tightly abut against a first tab, thereby improving the conduction efficiency of heat on an electrode plate. In another aspect, a second gap is provided, so that a conduction channel is formed around a periphery of the first tab, and thus heat of the electrode plate surrounding the first tab can be uniformly and quickly conducted to the periphery of the first tab. Therefore, the heat dissipation efficiency of the jelly roll is improved, thereby ensuring that the jelly roll can effectively dissipate heat during a high-rate charging/discharging process, and thus improving the performance of the jelly roll such as the safety. In addition, the following beneficial effects can be achieved by the thinning groove. In one aspect, because part of an active material is reserved in the thinning groove, a solder print of the first tab can abut against the active material in the thinning groove, and the active material in the thinning groove and an active material in a peripheral region of the thinning groove are arranged continuously, so that heat of the electrode plate can also be dissipated quickly through the active material abutting against the solder print of the first tab, thereby further improving the heat dissipation efficiency of the jelly roll. In another aspect, the thinning groove is provided to reduce a thickness of the first tab, so as to reduce an overall thickness of the jelly roll, so that the space utilization of the jelly roll is improved, thereby improving energy density.

The following describes content of the present disclosure in detail with reference to the accompanying drawings, so that those skilled in the art can understand the content of the present disclosure clearly and in detail.

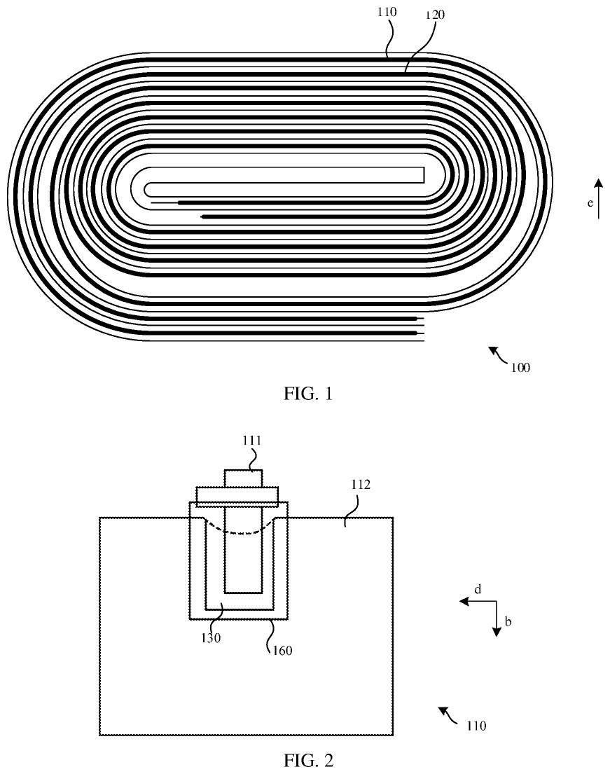

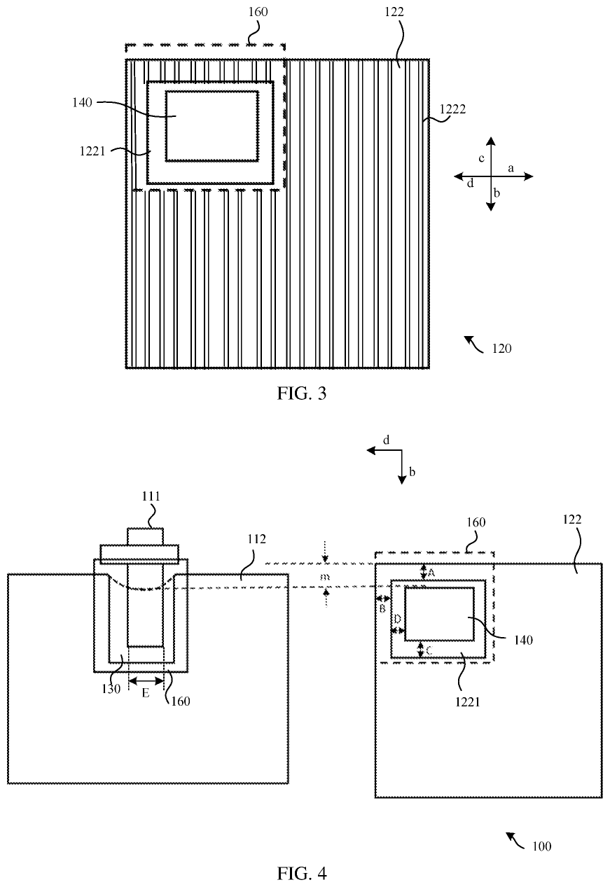

FIG. 1 is a schematic structural diagram of a jelly roll from a first angle of view according to an embodiment of the present disclosure. FIG. 2 is a schematic structural diagram of a first electrode plate in a jelly roll according to an embodiment of the present disclosure. FIG. 3 is a schematic structural diagram of a second electrode plate in a jelly roll according to an embodiment of the present disclosure. FIG. 4 is a schematic diagram of an unwound structure of a jelly roll according to an embodiment of the present disclosure.

As shown in FIG. 1 to FIG. 4, an embodiment of the present disclosure provides a jelly roll 100, including a first electrode plate 110, a separator, and a second electrode plate 120 that are wound together. The separator is arranged between the first electrode plate 110 and the second electrode plate 120 that are adjacent to each other. The first electrode plate 110 and the second electrode plate 120 have opposite polarities.

The first electrode plate 110 includes a first current collector and first active material layers 112 coated on two sides of the first current collector. A tab groove 130 is provided in the first active material layer 112. A bottom wall of the tab groove 130 is the first current collector. A peripheral side of the tab groove is the first active material layer 112. The tab groove 130 extends to an edge of the first current collector in a second direction. A first tab 111 that is electrically connected to the first current collector is arranged in the tab groove 130.

The second electrode plate 120 includes a second current collector 121 and second active material layers 122 coated on two sides of the second current collector 121. A thinning groove 1221 is provided in the second active material layer 122 opposite the tab groove 130. A thickness of the second active material layer 122 in the thinning groove 1221 is less than a thickness of the second active material layer 122 in a region that is of the second current collector 121 and is not provided with the thinning groove. First protective adhesive paper 140 is arranged in the thinning groove 1221. A projection of the first tab 111 in a first direction is in a projection of the first protective adhesive paper 140 in the first direction. The second current collector 121 is provided with a second edge in a second direction.

The thinning groove 1221 is arranged in a jelly roll straight section. A first gap is provided between the thinning groove 1221 and the second edge. A projection of the first gap in the first direction at least partially overlaps with a projection of the first tab 111 in the first direction. A second gap is provided between the thinning groove 1221 and a jelly roll arc section on a side that is most adjacent to the thinning groove.

It should be noted that the projection of the first tab 111 in the first direction being in the projection of the first protective adhesive paper 140 in the first direction indicates that: with reference to FIG. 1, in an orthographic projection perpendicular to a plane having the first direction, namely, in an orthographic projection of a plane where the first protective adhesive paper 140 is located, in a width direction of the first tab 111, a width of the first tab 111 is not greater than a width of the first protective adhesive paper 140.

It should be noted that as shown in FIG. 1, the first direction e is a thickness direction of the jelly roll 100. As shown in FIG. 2, FIG. 3, and FIG. 4, the second direction b is a width direction of the electrode plate; and a third direction d is a length direction of the electrode plate.

It may be understood that part of the first tab 111 in a thickness direction may be arranged in the thinning groove 1221, and may reduce the thickness of the first tab 111, so as to reduce a stacking thickness at the first tab 111. Therefore, flatness of the jelly roll is further improved, thereby reducing the thickness of the jelly roll to some extent, and improving the space utilization and energy density of a battery.

It should be noted that during a charging/discharging process of the battery, the electrode plate of the jelly roll is prone to generate heat because of an electrochemical reaction. Especially, the second electrode plate is a negative electrode plate that is generally made of a material such as graphite or silicon, resulting in that the electrode plate generates more heat than a positive electrode plate. Moreover, during a high-rate charging/discharging process, the electrochemical reaction is more violent, resulting in that heat generated by the electrode plate increases exponentially. In one aspect, the tab is generally made of nickel, copper, aluminum, another metal, or an alloy, so that the heat-conducting property of the tab is relatively excellent. In another aspect, the tab generally extends to an outer side of the electrode plate and is in contact with external air, so that the electrode plate can dissipate the vast majority of heat through the tab.

In addition, it should be noted that with reference FIG. 1 to FIG. 3, the jelly roll includes a jelly roll straight section and two jelly roll arc sections. The two jelly roll arc sections are respectively arranged on two sides of the jelly roll straight section. The jelly roll is formed by winding the positive electrode plate, the separator, and the negative electrode plate sequentially along a head of the jelly roll. Accordingly, each layer of the electrode plate includes a straight section and at least one arc section. From a winding center of the jelly roll outwards, the straight sections and the arc sections of a plurality of layers of the electrode plates are stacked sequentially to form the jelly roll straight section and the two jelly roll arc sections.

In addition, the positive electrode plate, the negative electrode plate, and the separator are relatively thin, all their thicknesses are measured in micrometers (μm), and the positive electrode plate, the negative electrode plate, and the separator are wound tightly to improve the unit energy density of a battery cell, so that the positive electrode plate, the negative electrode plate, and the separator are attached to one another tightly. Therefore, a diameter of the arc section of the jelly roll is relatively small. Especially, an electrode plate closer to the winding center has a winding radius closer to zero. Moreover, because an electrode plate at an arc section closer to the winding center has a larger angle, an active layer on a surface of the electrode plate is more prone to thin or even fracture during bending and stretching, that is, the active layer on the surface of the electrode plate at the arc section may become discontinuous. In this case, if the tab is disposed adjacent to the arc section, the second gap between an electrode plate opposite the tab and an active layer that is between the arc section and an electrode plate where the tab is located is close to zero. In addition, with reference to the above-described phenomenon that the active layer on the surface of the arc section fractures or thins, heat of the active layer adjacent to the arc section cannot be effectively conducted to the tab. As shown in FIG. 3, conduction of heat from the second active material layer 122 to the first tab 111 in the direction d is blocked, which affects heat dissipation of the electrode plate.

After being wound, the first tab 111 has a relatively large blank area in a direction of the straight section of the second active material layer 122, namely, the direction a and the direction b in FIG. 3. Therefore, heat conduction to the tab in the two directions has a relatively good effect. However, in the prior art, no active layer is reserved in front of the first tab 111 in a direction c and/or a direction d. Therefore, heat of the second active material layer conducted to the first tab 111 in the direction a and the direction b is relatively less, which reduces the heat dissipation efficiency of the electrode plate.

Therefore, in the present disclosure, blank areas are added in front of the first tab 111 in the direction c and the direction d, that is, the first gap is provided between a top end of the thinning groove 1221 and an edge of the second active material layer 122, so that in the direction c, the first tab 111 can abut against the second active material layer 122, and heat generated by the second active material layer 122 can be transferred to the first tab 111 through heat conduction to implement fast heat dissipation. Moreover, in the direction d, the second gap is provided between a side wall of the thinning groove 1221 and an arc section of the second active material layer 122. Meanwhile, two ends of the second gap are respectively communicated with the first gap and a large-area active layer at a bottom; and two ends of the first gap are respectively communicated with the second gap and a large-area active layer on a right side. Therefore, a circular conducting channel is formed between peripheries of the thinning groove 1221 and the first tab 111, through which heat conducted from the second active material layer 122 to the first tab 111 in the direction a and the direction b can be further transferred to the first gap and the second gap. In this case, heat generated by the electrode plate may be conducted around the first tab 111, thereby improving the heat conduction and heat dissipation efficiency of the first tab 111.

The following beneficial effect can be achieved by using the above configurations. In one aspect, the first gap is provided, so that the second active material layer 122 at the first gap can tightly abut against the first tab 111, thereby improving the conduction efficiency of heat on the electrode plate. In another aspect, the second gap is provided, so that a conduction channel is formed around the periphery of the first tab 111, and thus heat of the electrode plate surrounding the first tab 111 can be uniformly and quickly conducted to the periphery of the first tab 111. Therefore, the heat dissipation efficiency of the jelly roll 100 is improved, thereby ensuring that the jelly roll 100 can effectively dissipate heat during a high-rate charging/discharging process, and thus improving the performance of the jelly roll 100 such as safety. In addition, the following beneficial effects can be achieved by the thinning groove 1221. In one aspect, because part of an active material is reserved in the thinning groove 1221, a solder print of the first tab 111 can abut against the active material in the thinning groove 1221, and the active material in the thinning groove 1221 and an active material in a peripheral region of the thinning groove are arranged continuously, so that heat of the electrode plate can also be dissipated quickly through the active material abutting against the solder print of the first tab 111, thereby further improving the heat dissipation efficiency of the jelly roll. In another aspect, the thinning groove is provided to reduce a thickness of the first tab 111, so as to reduce an overall thickness of the jelly roll 100, so that the space utilization of the jelly roll 100 is improved, thereby improving energy density.

It should be noted that the second current collector 121 is a high-strength copper foil current collector having a tensile strength ranging from 300 MPa to 700 MPa, an elongation ranging from 2.0% to 11%, and a surface density ranging from 30 g/m² to 65 g/m². This configuration is intended to effectively resolve the problem that the second current collector 121 is fractured due to a stress difference generated when the second current collector is melted during the welding process. Moreover, burrs at a solder joint can be reduced effectively to reduce a puncture risk; a tensile strength value at a welding position can be increased; and a contact resistance is reduced and thus an internal resistance of the jelly roll is reduced.

The first electrode plate 110 in this embodiment of the present disclosure may be a positive electrode plate, where the first current collector is a positive electrode current collector; the first active material layer 112 is a positive electrode active material layer; and the first tab 111 is a positive electrode tab.

The second electrode plate 120 may be a negative electrode plate, where the second current collector 121 is a negative electrode current collector; the second active material layer 122 is a negative electrode active material layer; and the second tab is a negative electrode tab.

Correspondingly, in some other embodiments, the first electrode plate 110 may alternatively be a negative electrode plate; and the second electrode plate 120 may alternatively be a positive electrode plate. Principles of the electrode plates are the same as or similar to those described above. Details are not described herein again.

As shown in FIG. 1 to FIG. 4, in some implementations, a width of the first gap in the second direction is A; and a width of the second gap in a third direction of the first current collector is B, where A and B meet: 2 mm<B, and/or 0.8≤A/B≤1.2.

It should be noted that the second gap may be 2.5 mm, 3 mm, 3.5 mm, 4 mm, or the like. A value of the second gap is not limited.

In addition, a ratio of the first gap A to the second gap B is greater than or equal to 0.8 and less than or equal to 1.2. This is because an extended region of the first gap A overlaps with an extended region of the second gap B, resulting in that too much heat is accumulated at an overlapping position, and the heat cannot be dissipated quickly.

In addition, because a joint between the first gap A and the second gap B is adjacent to a corner of the electrode plate, the problem of inefficient conduction of heat at the joint between the first gap A and the second gap B is solved effectively by setting A/B to be greater than or equal to 0.8 and less than or equal to 1.2, that is, setting the width of the first gap A to be close to the width of the second gap B. In this case, a large amount of heat generated due to heat accumulation at the joint between the first gap A and the second gap B can be effectively avoided, thereby effectively avoiding the following phenomenon: an aluminum-plastic film at a top corner of the battery cell close to the tab is melted and fractured due to an abnormal heat rise, namely, corner crack.

In some implementations, a first notch is provided in the first current collector located in the tab groove 130, where the first notch is provided in a first edge of the first current collector; the first notch is communicated with the tab groove 130; the first notch extends to an edge of the first current collector; and a distance between a projection of a bottom wall of the first notch in the second direction and the second edge is m, where m meets: m>A.

It should be noted that the first notch is an arc-shaped punch region of the first tab 111; the bottom wall of the first notch is the deepest portion of the first notch in the first current collector; and m is a distance from a projection of the bottom wall of the first notch on the second active material layer 122 to an edge of the second active material layer 122. This configuration is intended to avoid superposition between the first tab 111 and aluminum foil, so as to reduce a thickness of this position, thereby reducing an ineffective thickness of the jelly roll, improving the energy density of a lithium-ion battery, increasing space utilization, and thus prolonging the battery life of an electronic product.

As shown in FIG. 1 to FIG. 4, in some implementations, in the second direction, a distance between the first protective adhesive paper 140 and an edge of the thinning groove 1221 is C, where C meets: 0 mm<C<5 mm; and/or

in a length direction of the first current collector, a distance between the first protective adhesive paper 140 and an edge of the thinning groove 1221 is D, where D meets: 0 mm<D<5 mm.

It should be noted that due to this configuration, a region covered by the first protective adhesive paper 140, the thinning groove 1221, and the second active material layer 122 form a stepped funnel due to thickness difference, thereby facilitating storing an electrolyte solution in the stepped funnel. The electrolyte solution absorbs heat generated by the first tab 111, so as to reduce a temperature rise. In addition, particularly, the electrolyte solution may effectively fill a gap between the thinning groove 1221 and the first protective adhesive paper 140, so that heat on the first protective adhesive paper 140 abutting against the first tab 111 can be continuously conducted to the first gap and the second gap through the electrolyte solution, thereby improving the conduction efficiency of the heat.

It should be noted that the distance between the first protective adhesive paper 140 and the edge of the thinning groove 1221 may be 1 mm, 2 mm, 3 mm, 4 mm, or another value.

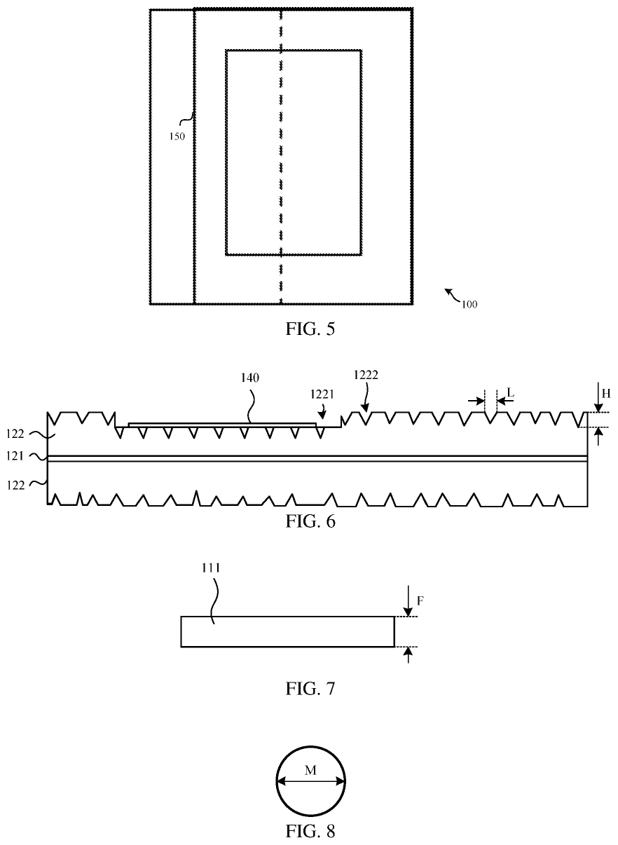

FIG. 5 is a schematic structural diagram of a jelly roll from a second angle of view according to an embodiment of the present disclosure. FIG. 6 is a sectional view of a second electrode plate in a jelly roll according to an embodiment of the present disclosure.

As shown in FIG. 1 to FIG. 6, in some implementations, a plurality of first grooves 1222 are provided in the second active material layer 122; and the first groove extends in the second direction.

The plurality of first grooves 1222 are spaced in at least one of an arc section of the second active material layer 122 or a straight section of the second active material layer 122.

It should be noted that the first groove 1222 is provided, so that heat at the first tab 111 is dissipated to an outer side of the jelly roll, that is, the heat at the first tab 111 may be dissipated towards the second active material layer 122 and the arc section of the second active material layer 122, and then dissipated through a first heat dissipation channel in the first groove 1222, thereby facilitating heat dissipation.

In some embodiments, the first groove 1222 may be a complete linear first groove 1222 formed by using a laser, or a spliced linear first groove 1222 including a plurality of lines formed by using lasers, which mainly depends on a size of a laser device. A width of a line formed by etching at a time is related to the size of the device. If the electrode plate is too wide, it is required to splice a plurality of lines formed by etching. Moreover, with reference to FIG. 3, at least some of the linear first grooves 1222 are communicated with an edge of the electrode plate and the thinning groove 1221, so that the electrolyte solution is quickly and sufficiently immersed in the gap between the first protective adhesive paper 140 and the thinning groove 1221, thereby improving the heat conduction and heat dissipation efficiency of the first tab 111.

In some embodiments, a length direction of the first groove 1222 may keep consistent with a width direction of the thinning groove 1221, or may keep consistent with a length direction of the thinning groove 1221, or may be any direction, provided that heat of the first groove can be dissipated.

In some other embodiments, a sectional shape of the first groove 1222 is any one of a rectangle, a trapezoid, a taper, an arc, or a column. During specific implementation, the first groove 1222 may be formed via at least one of laser ablation, tool cutting, stamping, or another manner. A sectional shape of a first heat dissipation channel formed may be a square, a trapezoid, a rectangle, or the like. This is not limited in this embodiment.

In some implementations, a pore is defined between the first electrode plate 110 and the second electrode plate 120 on the arc section of the second active material layer 122; and the pore has a second heat dissipation channel.

It should be noted that bonding performance between interfaces in an arc region of the jelly roll 100 is poorer than that in a flat region thereof. Because the flat region is compressed when the jelly roll is pressed downwards in a thickness direction of the jelly roll, a pore is defined between the first electrode plate 110 and the second electrode plate 120 on the arc section. The pore has a second heat dissipation channel, so as to dissipate heat at the first tab 111 outwards to an outer side of the jelly roll.

In addition, the arc region has a pore, which not only facilitates release of stress on the arc region, but also provides a second heat dissipation channel. A second gap is provided between the thinning groove 1221 and the arc region, which neither blocks the second heat dissipation channel nor affects the heat conduction and gas guiding effects in this region.

As shown in FIG. 1 to FIG. 6, in some implementations, a depth H of the first groove 1222 and a fracture elongation e of the second current collector 121 meet: 1 mm≤H/e≤15 mm.

It should be noted that a larger fracture elongation of the current collector indicates that the current collector can bear a larger stress and a larger laser intensity, and indicates that the first groove 1222 is deeper.

FIG. 7 is a schematic structural diagram of a first tab in a jelly roll according to an embodiment of the present disclosure. As shown in FIG. 1 to FIG. 7, in some implementations, the depth H of the first groove 1222, a width L of the first groove 1222, a tab width E of the first tab 111 or the second tab, and a tab thickness F of the first tab 111 or the second tab meet: 2*10⁻⁴ mm⁴≤H*L*E*F≤2*10⁻³ mm⁴.

It should be noted that a smaller width or thickness of the first tab 111 or the second tab leads to generation of more heat, which requires a larger area of a heat-conducting and gas-guiding channel.

Specifically, a resistance R of a metal strip of the tab is equal to ρL/S, where L denotes a length, and S denotes an area. In a case that a charging/discharging current remains unchanged, a smaller value of S leads to a larger value of the resistance, and a larger value of the resistance leads to more serious heat generation.

As shown in FIG. 1 to FIG. 7, in some implementations, a ceramic layer is coated on at least one side surface of the first electrode plate 110 away from a tail end of a winding center; and part of the ceramic layer covers the first active material layer 112.

A coating thickness of the ceramic layer is greater than or equal to 5 μm and less than or equal to 20 μm; and/or

a ratio of a ceramic particle size of the ceramic layer to a width of the first groove 1222 is greater than or equal to 1/20 and less than or equal to ¼.

It should be noted that the ceramic layer facilitates heat absorption, so as to reduce an overall temperature rise of a battery.

In some embodiments, aluminum foil at a tail end of the first electrode plate 110 is coated with a ceramic layer, where ceramics may be coated on two surfaces or one surface of the aluminum foil.

In addition, setting of the foregoing values can effectively prevent the following problem: the ceramics are detached and blocks the first groove 1222, which affects heat conduction of the battery cell.

In some embodiments, the coating thickness of the ceramic layer may be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, or may be any value between 5 μm and 20 μm.

In some embodiments, the ratio of the ceramic particle size of the ceramic layer to the width of the first groove 1222 may be 0.05, 0.1, 0.15, 0.2, 0.25, or any value between 0.05 and 0.25.

In some implementations, a second groove is provided in the first active material layer 112 away from the tail end of the winding center; and part of the ceramic layer covers the second groove.

A depth of the second groove is greater than or equal to 0 μm and less than or equal to 20 μm.

It should be noted that the second groove is used to offset the thickness of the ceramic layer and to facilitate reduction of the thickness of the ceramic layer, thereby preventing an overlapping region from being thicker than other positions, which affects flatness of a battery cell. Ceramics facilitate heat absorption, so as to reduce an overall temperature rise of a battery.

In some embodiments, the thickness of the second groove may be 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, or 20 μm, or any value between 1 μm and 20 μm.

In some implementations, at least part of a projection of the ceramic layer in the thickness direction of the jelly roll 100 is located in the thinning groove 1221.

It should be noted that due to this configuration, in the thickness direction of the jelly roll 100, heat generated by the first tab 111 is perpendicularly conducted to the ceramic layer, thereby shortening a heat-conducting path and thus improving the heat conduction and heat dissipation efficiency of the jelly roll 100.

In some implementations, the second active material layer 122 includes a first material layer and a second material layer; and the first material layer and the second material layer are stacked sequentially in the first direction, where the first material layer is arranged on a side away from the second current collector 121.

It should be noted that the second active material layer 122 includes two layers, where materials of the first material layer and the second material layer may be the same or may be different.

In some implementations, at least one of the first material layer or the second material layer is made of a silicon-doped graphite material, where a particle size of a graphite particle of the first material layer is smaller than a particle size of a graphite particle of the second material layer.

A ratio of a thickness of the first material layer to a thickness of the second active material layer 122 is greater than or equal to 20% and less than or equal to 60%.

The thickness of the second active material layer 122 is greater than the depth of the first groove 1222.

In some embodiments, the thickness of the first material layer may be greater than the depth of the first groove 1222, or may be less than or equal to the depth of the first groove 1222.

It should be noted that the second active material layer 122 includes two layers of graphite, where graphite of the lower layer is large-particle graphite, graphite of the upper layer is small-particle graphite, and a ratio of a thickness of the small-particle graphite of the upper layer to a total thickness of the second active material layer 122 ranges from 20% to 60%. A linear first groove 1222 is formed by etching the second electrode plate 120 by using a laser. A depth h of the first groove 1222 is less than the thickness of the first material layer. A porosity of the small-particle graphite of the upper layer is larger, thereby facilitating gas guiding and heat conduction.

It should be noted that silicon materials doped in the first material layer and the second material layer may be the same silicon material or may be different silicon materials. For different silicon materials, there is no requirement for sizes of particles of the upper layer and the lower layer. Herein, only particle sizes of graphite particles are still specified. A particle size of a graphite particle of the first material layer is smaller than a particle size of a graphite particle of the second material layer.

FIG. 8 is a schematic structural diagram of a particle of a silicon-carbon material in a jelly roll according to an embodiment of the present disclosure. As shown in FIG. 1 to FIG. 8, in some implementations, at least one of the first material layer or the second material layer is made of a mixed material including at least one of a graphite material or a silicon-carbon material, where a ratio of the silicon-carbon material to the mixed material is greater than or equal to 2% and less than or equal to 15%; and/or

a width L of the first groove 1222 and a particle size M of the silicon-carbon material meet:L≥2M, where 50 μm≤L≤100 μm.

The second active material layer 122 has a double-layer structure, that is, at least one of the first material layer or the second material layer is made of a mixed material including at least one of a graphite material or a silicon-carbon material.

It should be noted that the second active material layer 122 is made of a silicon-carbon-doped graphite material. Silicon-carbon particles undergo relatively large expansion during a charging/discharging process. Compared with graphite, silicon-carbon undergoes more side reactions when being in contact with an electrolyte solution, resulting generation of gas and heat. A linear first groove 1222 is formed by etching the second electrode plate 120 by using a laser, so that sufficient space is provided to ensure that the silicon-carbon material undergoing expansion during a cyclic charging and discharging process can be accommodated and that the first heat dissipation channel is unobstructed.

In some implementations, a lithium supplement layer is arranged on a side surface of the second electrode plate 120; and a thickness of the lithium supplement layer is less than or equal to a depth of the first groove 1222.

It should be noted that because the surface of the second electrode plate 120 is provided with the lithium supplement layer, and the depth h of the first groove 1222 is greater than the thickness of the lithium supplement layer, so that a linear channel of the first groove 1222 still exists in the surface of the electrode plate subjected to lithium supplement, thereby facilitating gas guiding and heat conduction.

In addition, it should be noted that lithium is supplemented in one or a combined manner of the following manners: forming the lithium supplement layer by heating a lithium metal to obtain a molten lithium metal and casting or coating the molten lithium metal on a coating layer of an electrode material; forming the lithium supplement layer by oscillating a powdery lithium metal to the electrode plate and then calendering the lithium metal; or forming the lithium supplement layer by directly extruding a solid lithium metal to a surface of the electrode plate. However, a relatively large amount of heat is generated during lithium supplement processes performed in the foregoing lithium supplement manners, and it is difficult to discharge the heat. As a result, the safety performance of a lithium battery cannot be guaranteed. Therefore, the first groove 1222 is provided, a linear channel of the first groove 1222 still exists in the surface of the electrode plate subjected to lithium supplement, thereby facilitating gas guiding and heat conduction.

As shown in FIG. 1 to FIG. 8, in some implementations, second protective adhesive paper 150 is arranged at a tail end of the first electrode plate 110; and a ratio of a width of the second protective adhesive paper 150 to a width of the jelly roll 100 is greater than or equal to ½ and less than or equal to 1; and/or

the width of the second protective adhesive paper 150 is greater than or equal to 10 mm and less than or equal to 40 mm.

It should be noted that the second protective adhesive paper 150 is guaranteed to exceed tail-end bare foil (or be coated with a ceramic layer) after passing over an arc, and that an adhesive bonding relationship between the second protective adhesive paper 150 and tail-end hot-melt adhesive is as follows: In a width direction of the jelly roll, the second protective adhesive paper 150 exceeds the hot-melt adhesive, and the hot-melt adhesive is bonded above the second protective adhesive paper 150, so that the hot-melt adhesive can be prevented from tearing the first electrode plate 110.

In some embodiments, the width of the second protective adhesive paper 150 may be 15 mm, 20 mm, 25 mm, 30 mm, 35 mm, or 40 mm, or any value between 15 mm and 40 mm.

As shown in FIG. 1 to FIG. 8, in some implementations, third protective adhesive paper 160 is arranged on the tab groove 130 in a side of the first electrode plate 110; and the third protective adhesive paper 160 is configured to cover the thinning groove 1221.

It should be noted that the third protective adhesive paper 160 can prevent a short-circuit fire risk caused when a burr of a solder joint at the first tab 111 pierces through a separator.

It should be noted that the following table 1 is a table in which a plurality of sets of example data are compared.

TABLE 1
Temperature rise data of a plurality
of Examples and Comparative Example

| | Thickness | Temperature | Temperature rise |
|---|---|---|---|
| | of a battery | rise at a | of a battery |
| | cell (mm) | tab (° C.) | cell body (° C.) |
| Comparative | 5.689 | 16.53 | 15.98 |
| Example | | | |
| Example 1 | 5.665 | 16.14 | 15.55 |
| Example 2 | 5.665 | 18.8 | 17.99 |
| Example 3 | 5.665 | 17.74 | 16.32 |
| Example 4 | 5.665 | 20.77 | 19.56 |
| Example 5 | 5.665 | 18.84 | 18.22 |
| Example 6 | 5.665 | 17.75 | 16.32 |
| Example 7 | 5.645 | 16.15 | 14.37 |
| Example 8 | 5.645 | 16.16 | 14.39 |

Comparative Example differs from Example 1 in that in Comparative Example, no thinning groove 1221 was provided in the second electrode plate 120.

Example 2 differs from Example 1 in that a distance A from the thinning groove 1221 to an edge of the electrode plate was 0.

Example 3 differs from Example 1 in that no linear first groove 1222 was formed by etching a surface of the second electrode plate 120 by using a laser.

Example 4 differs from Example 1 in that a specification of the tab was 4 mm*0.08 mm.

Example 5 differs from Example 1 in that a depth of a linear first groove 1222 formed by etching a surface of the second electrode plate 120 by using a laser was 30 μm.

Example 6 differs from Example 1 in that a width of a linear first groove 1222 formed by etching a surface of the second electrode plate 120 by using a laser was 20 μm.

Example 7 differs from Example 1 in that no ceramic layer was provided at a tail of the first electrode plate 110.

Example 8 differs from Example 1 in that a width of the second protective adhesive paper 150 on a short surface of the first electrode plate 110 was 10 mm.

The jelly roll provided in the examples of the present disclosure includes a first electrode plate and a second electrode plate, where the first electrode plate includes a first current collector and first active material layers coated on two sides of the first current collector; a first tab groove is provided in the first active material layer; a bottom wall of the first tab groove is the first current collector; a peripheral side of the first tab groove is the first active material layer; the first tab groove extends to an edge of the first current collector in a second direction; a first tab that is electrically connected to the first current collector is arranged in the first tab groove; the second electrode plate includes a second current collector and second active material layers coated on two sides of the second current collector; a thinning groove is provided in the second active material layer opposite the first tab groove; a thickness of the second active material layer in the thinning groove is less than a thickness of the second active material layer in a region that is of the second current collector and is not provided with the thinning groove; first protective adhesive paper is arranged in the thinning groove; a projection of the first tab in a first direction is in a projection of the first protective adhesive paper in the first direction; the second current collector is provided with a second edge in a second direction; the thinning groove is arranged in a jelly roll straight section; a first gap is provided between the thinning groove and the second edge; a projection of the first gap in the first direction at least partially overlaps with a projection of the first tab in the first direction; and a second gap is provided between the thinning groove and a jelly roll arc section on a side that is most adjacent to the thinning groove.

In one aspect, the first gap is provided, so that the second active material layer at the first gap can tightly abut against the first tab, thereby improving the conduction efficiency of heat on the electrode plate. In another aspect, the second gap is provided, so that a conduction channel is formed around a periphery of the first tab, and thus heat of the electrode plate surrounding the first tab can be uniformly and quickly conducted to the periphery of the first tab. Therefore, the heat dissipation efficiency of the jelly roll is improved, thereby ensuring that the jelly roll can effectively dissipate heat during a high-rate charging/discharging process, and thus improving the performance of the jelly roll such as safety. In addition, the following beneficial effects can be achieved by the thinning groove. In one aspect, because part of an active material is reserved in the thinning groove, a solder print of the first tab can abut against the active material in the thinning groove, and the active material in the thinning groove and an active material in a peripheral region of the thinning groove are arranged continuously, so that heat of the electrode plate can also be dissipated quickly through the active material abutting against the solder print of the first tab, thereby further improving the heat dissipation efficiency of the jelly roll. In another aspect, the thinning groove is provided to reduce a thickness of the first tab, so as to reduce an overall thickness of the jelly roll, so that the space utilization of the jelly roll is improved, thereby improving energy density.

In addition, an embodiment of the present disclosure further provides a battery, including the jelly roll 100.

The battery is not limited to a lithium battery. In the future, this technology may be applied to a sodium battery or the like. Preferably, the battery in this embodiment of the present disclosure is a lithium-ion battery.

A specific structure, an operating principle, and a function of the jelly roll 100 are described in detail in the foregoing embodiments. Details are not described herein again. It should be noted that a preparation process of the lithium-ion battery includes step 1 to step 4 as follows.

Step 1: Preparation of a positive electrode plate: positive electrode active layer slurry was prepared. Positive electrode active material slurry and ceramic slurry were coated on a surface of a current collector by means of gravure coating or skip coating. Baking and roll-pressing were performed to obtain the positive electrode plate, where a groove having a fixed size was formed at a specific position of the positive electrode plate. A 6 mm*0.08 mm nickel tab was welded into the groove by using a laser or ultrasound, where a width of second protective adhesive paper on a short surface of the positive electrode plate was 35 mm.

Step 2: Two different types of negative electrode active layer slurry were prepared and were coated on carbon-coated copper foil. Baking and roll-pressing were performed to obtain a negative electrode plate, where a thickness of coating paste on a bottom layer was 50 μm, a thickness of coating paste on an upper layer was 20 μm, and a groove having a fixed size was formed at a specific position of the negative electrode plate. A 6 mm*0.08 mm copper-plated nickel tab was welded into the groove by using a laser or ultrasound. In addition, a thinning groove 1221 was formed at a position of a projection of a positive tab welding region on the negative electrode plate, where a depth of the thinning groove 1221 was 25 μm, a distance A from the thinning groove 1221 to an edge of the electrode plate was 2 mm, and a distance from the thinning groove to an arc region was 1 mm. A linear first groove 1222 was uniformly formed by etching a surface of the negative electrode plate by using a laser having a specific intensity, where a depth h of the first groove 1222 was 15 μm, and a width L thereof was 80 μm.

Step 3: Cutting and fabrication were performed on the positive electrode plate and the negative electrode plate, and the processed positive and negative electrode plates were wound together with a separator, so as to obtain a jelly roll.

Step 4: Finally, encapsulation, baking, electrolyte injection, formation, secondary encapsulation, sorting and OCV were performed on the jelly roll to obtain the lithium-ion battery.

The electrolyte solution was a commercially available conventional electrolyte solution, and a lithium salt therein was LiFP₆.

The battery provided in this embodiment of the present disclosure can achieve the following beneficial effects. In one aspect, the first gap is provided, so that the second active material layer at the first gap can tightly abut against the first tab, thereby improving the conduction efficiency of heat on the electrode plate. In another aspect, the second gap is provided, so that a conduction channel is formed around a periphery of the first tab, and thus heat of the electrode plate surrounding the first tab can be uniformly and quickly conducted to the periphery of the first tab. Therefore, the heat dissipation efficiency of the jelly roll is improved, thereby ensuring that the jelly roll can effectively dissipate heat during a high-rate charging/discharging process, and thus improving the performance of the jelly roll such as safety. In addition, the following beneficial effects can be achieved by the thinning groove. In one aspect, because part of an active material is reserved in the thinning groove, a solder print of the first tab can abut against the active material in the thinning groove, and the active material in the thinning groove and an active material in a peripheral region of the thinning groove are arranged continuously, so that heat of the electrode plate can also be dissipated quickly through the active material abutting against the solder print of the first tab, thereby further improving the heat dissipation efficiency of the jelly roll. In another aspect, the thinning groove is provided to reduce a thickness of the first tab, so as to reduce an overall thickness of the jelly roll, so that the space utilization of the jelly roll is improved, thereby improving energy density.

Finally, it should be noted that the foregoing embodiments are merely intended for describing the technical solutions of the present disclosure, but not for limiting the present disclosure. Although the present disclosure is described in detail with reference to the foregoing examples, persons of ordinary skill in the art should understand that they may still make modifications to the technical solutions described in the foregoing examples or make equivalent replacements to some or all technical features thereof without departing from the scope of the technical solutions of the examples of the present disclosure.

What is claimed is:

1. A jelly roll, comprising a first electrode plate and a second electrode plate, wherein
the first electrode plate comprises a first current collector and first active material layers coated on two sides of the first current collector; a tab groove is provided in the first active material layer; a bottom wall of the tab groove is the first current collector; a peripheral side of the tab groove is the first active material layer; and a first tab that is electrically connected to the first current collector is arranged in the tab groove;
the second electrode plate comprises a second current collector and second active material layers coated on two sides of the second current collector; a thinning groove is provided in the second active material layer opposite the tab groove; a thickness of the second active material layer in the thinning groove is less than a thickness of the second active material layer in a region that is of the second current collector and is not provided with the thinning groove; first protective adhesive paper is arranged in the thinning groove; in a width direction of the first tab, a width of the first tab is not greater than a width of the first protective adhesive paper; and the second current collector has a second edge in a second direction; and
a first gap is provided between the thinning groove and the second edge; a projection of the first gap in a first direction at least partially overlaps with a projection of the first tab in the first direction; and a second gap is provided between the thinning groove and a jelly roll arc section on a side that is most adjacent to the thinning groove.

2. The jelly roll according to claim 1, wherein a width of the first gap in the second direction is A; and a width of the second gap in a third direction of the first current collector is B, A and B meet: 2 mm<B, and/or 0.8≤A/B≤1.2.

3. The jelly roll according to claim 2, wherein a first notch is provided in a first edge of the first current collector; the first notch is communicated with the tab groove; the first notch extends to an edge of the first current collector; and a distance between a projection of a bottom wall of the first notch in the second direction and the second edge is m, m meets: m>A.

4. The jelly roll according to claim 1, wherein in the second direction, a distance between the first protective adhesive paper and an edge of the thinning groove is C, C meets: 0 mm<C<5 mm; and/or
in a length direction of the first current collector, a distance between the first protective adhesive paper and an edge of the thinning groove is D, D meets: 0 mm<D<5 mm.

5. The jelly roll according to claim 1, wherein a plurality of first grooves are provided in the second active material layer; and the first groove extends in the second direction; and
the plurality of first grooves are spaced in an arc section of the second active material layer and/or a straight section of the second active material layer.

6. The jelly roll according to claim 5, wherein a depth H of the first groove and a fracture elongation e of the second current collector meet: 1 mm<H/e≤15 mm; and
the second electrode plate is further provided with a second tab; and a depth H of the first groove, a width L of the first groove, a tab width E of either the first tab or the second tab, and a tab thickness F of either the first tab or the second tab meet: 2*10⁻⁴ mm⁴≤H*L*E*F≤2*10⁻³ mm⁴.

7. The jelly roll according to claim 5, wherein a ceramic layer is coated on at least one side surface of the first electrode plate away from a tail end of a winding center; and part of the ceramic layer covers the first active material layer;
a coating thickness of the ceramic layer is greater than or equal to 5 μm and less than or equal to 20 μm; and/or
a ratio of a ceramic particle size of the ceramic layer to a width of the first groove is greater than or equal to 1/20 and less than or equal to ¼.

8. The jelly roll according to claim 7, wherein a second groove is provided in the first active material layer away from the tail end of the winding center; and part of the ceramic layer covers the second groove; and
a depth of the second groove is greater than or equal to 0 μm and less than or equal to 20 μm.

9. The jelly roll according to claim 8, wherein at least part of a projection of the ceramic layer in the first direction is located in the thinning groove.

10. The jelly roll according to claim 5, wherein the second active material layer comprises a first material layer and a second material layer; and the first material layer and the second material layer are stacked sequentially in the first direction, the first material layer is arranged on a side away from the second current collector.

11. The jelly roll according to claim 10, wherein at least one of the first material layer or the second material layer is made of a silicon-doped graphite material, a particle size of a graphite particle of the first material layer is smaller than a particle size of a graphite particle of the second material layer; and
a ratio of a thickness of the first material layer to a thickness of the second active material layer is greater than or equal to 20% and less than or equal to 60%.

12. The jelly roll according to claim 10, wherein at least one of the first material layer or the second material layer is made of a mixed material comprising at least one of a graphite material or a silicon-carbon material, a ratio of the silicon-carbon material to the mixed material is greater than or equal to 2% and less than or equal to 15%; and/or
a width L of the first groove and a particle size M of the silicon-carbon material meet:L≥2M, 50 μm≤L≤100 μm.

13. The jelly roll according to claim 5, wherein the second electrode plate is provided with a lithium supplement layer; and a thickness of the lithium supplement layer is less than or equal to a depth of the first groove.

14. The jelly roll according to claim 1, wherein second protective adhesive paper is arranged at a tail end of the first electrode plate; and a ratio of a width of the second protective adhesive paper to a width of the jelly roll is greater than or equal to ½ and less than or equal to 1; and/or
the width of the second protective adhesive paper is greater than or equal to 10 mm and less than or equal to 40 mm.

15. The jelly roll according to claim 1, wherein third protective adhesive paper is arranged on the tab groove in a side of the first electrode plate; and the third protective adhesive paper is configured to cover the thinning groove.

16. The jelly roll according to claim 1, wherein a plurality of first grooves are provided in the thinning groove.

17. The jelly roll according to claim 1, wherein in the first direction, a thickness of the first protective adhesive paper is not greater than a depth of the thinning groove.

18. The jelly roll according to claim 1, wherein the second current collector is a high-strength copper foil current collector;
a tensile strength of the second current collector ranges from 300 MPa to 700 MPa; and/or
an elongation of the second current collector ranges from 2.0% to 11%; and/or
a surface density of the second current collector ranges from 30 g/m² to 65 g/m².

19. The jelly roll according to claim 5, wherein in the second direction, at least a part of the plurality of first grooves is in communication with the thinning groove and an edge of the second active material layer.

20. A battery, comprising the jelly roll according to claim 1.
